(19) United States
(12) Patent Application Publication
(10) Pub. No.: US 2017/0173911 A1
(43) Pub. Date: Jun. 22, 2017

(54) METHOD AND DEVICE FOR EXTERNAL LUBRICATION OF PRESS ROLLS OF A ROLLER COMPACTION DEVICE AND APPLICATION OF THE METHOD

(71) Applicant: Paul GERTEIS, Wollerau (CH)

(72) Inventor: Paul GERTEIS, Wollerau (CH)

(21) Appl. No.: 15/117,144

(22) PCT Filed: Jan. 23, 2015
(86) PCT No.: PCT/CH2015/000006

§ 371 Date: Aug. 5, 2016

(30) Foreign Application Priority Data
Feb. 5, 2014 (CH) 147/14

(51) Int. Cl. B30B 15/00; A61J 3/00; B30B 15/30; B30B 11/18

(52) U.S. Cl. CPC B30B 15/0088; B30B 11/18; A61J 3/00; B30B 15/308; B01J 2/22

(57) ABSTRACT

In a method for external lubrication of the press rolls (2 or 2.1) of a roller compaction device (1) by means of a continuous coating of said press rolls (2 or 2.1), a thin layer of a lubricant and/or an anti-adhesive are continuously provided to coat the press rolls (2 or 2.1). This coating preferably contains magnesium stearate or a mixture containing magnesium stearate. To carry out the method, at least one coating device (13, 14, 15 or 13.1, 14.1, 15.1) is arranged in a housing in which the press rolls (2 and 2.1) are arranged, by means of which coating device at least one press roll is provided with a thin coating of a lubricant and/or an anti-adhesive, preferably with magnesium stearate or a mixture containing magnesium stearate. The method is used for the manufacture of dry granules in the pharmaceutical and food industries.

The invention relates to a method and a device for the external lubrication of the press rolls of a roller compaction device by a continuous coating of the press rolls with an appropriate lubricant as well as the use of the method.

Roller compactors according to the state of the art are known from EP-A-0525 135. The purpose of roller compactors is to compact powders into ribbons or flakes, which are subsequently milled to granules. This process is also called dry granulation. These dry granules are for instance used for the manufacture of tablets, capsules, sachets, batteries and instant meals.

An apparatus for applying a solid lubricant to a rotating surface in a toner cartridge is known from EP 1 764 661 A. The lubricant consists of a solid rod produced by melt extrusion. The rod contains zinc stearate and lubricating oils. Magnesium stearate is named as one of many possible stearates. First of all, in order to distribute the lubricant uniformly across the rotating surface, a small amount of lubricant is scraped off from the solid rod and then firmly pressed and smeared towards a thin film with the help of a blade scraper, which has to be pushed onto the roll surface with a well-defined force. It is essential for the use described that an extremely thin film of lubricant, which sticks well to the surface, is applied to the rotating roll as uniformly and consistently as possible. This film must not contain any lubricant aggregates. The applied amount of lubricant ranges from 0.11 to 1.2 mg/m² of roll surface. Any amount exceeding 1.2 mg/m² of roll surface is described as absolutely unsuitable.

Apart from the very fact that toner cartridges are not the object of this invention, the anti-adhesive properties in particular of magnesium stearate are negatively affected by extrusion processes.

Another disadvantage is the need for an additional blade scraper, which is used to press the lubricant onto the surface of the roll. A further disadvantage is that any particles applied to the roll surface in this process have to be removed completely from said surface with a cleaning device prior to applying the next lubricant layer. For this reason, only completely smooth rolls can be used for the process described in EP 1 764 661 A.

From DE 197 31 975 A1 a method is known that prevents sticking or caking of material intended for briquetting to the rolls of a briquetting press. The final product is a briquette. An emulsion is sprayed onto the surface of the press rolls. The emulsion consists of a mixture of graphite, water and gas. In the pharmaceutical and food industries, spray coating with an emulsion during the manufacture of dry granules is not possible at the typically low temperature range (20 to 50° C.), since this would require drying the compacted product, which would largely nullify the advantages of dry granulation.

During the manufacture of tablets using suitable presses, in general a lubricant has to be added to the powder to be compacted, with the aim of reducing the forces required for ejecting the tablet (out of the die after the powder/granulate densification process). This lubricant added to the powder/granulate is also called internal lubricant. Addition of such internal lubricant prevents mechanical damage to the tablet press. Often, the reduction in ejection force also prevents the tablet, just compacted and still located in the die, from being damaged during the ejection process, which for instance can be recognised when tablets are capping or laminating. Furthermore, such internal lubricant is also added to the formulation in order to prevent or reduce adhesion to the tableting tools (upper and/or lower punch and/or the die).

The lubricant used most often, in particular in the pharmaceutical industry, is magnesium stearate. However, this substance also has a number of undesirable properties. The addition of magnesium stearate usually causes a reduction of tablet strength. Due to the hydrophobic properties of this lubricant (magnesium stearate), also problems with the release of the active ingredient may occur, which may result in an impairment of the bio-pharmaceutical availability. In addition, both the problems with release and compatibility of the powder, like e.g. the reduction in tablet strength, can be significantly aggravated by more or less intensive mixing. In consequence, the magnesium stearate is distributed in such a way that it becomes impossible to produce tablets of sufficient mechanical strength, or release is reduced to such an extent that the intended effect in the body is not achieved at all or not to a sufficient extent.

Also during the processing of powder mixtures with roller compaction devices, lubricants are employed very frequently. Such lubricants serve the purpose to reduce friction during powder conveyance by the augers. Plug-formation in this transportation area can thus be largely prevented or at least reduced to such an extent that a sufficient amount of powder is conveyed for performing the process at the selected manufacturing conditions.

Additionally, a lubricant is added to the mixture to be roller compacted with the aim of preventing sticking/caking of powder/ribbon residues to the press rolls. However, this addition may result in problems similar to those during tablet manufacture: on the one hand a reduction in ribbon strength, resulting in a granulate with a larger amount of fines, and this, despite the same process conditions. This in turn leads to poorer flow properties of the granulate resulting in larger weight variations during tableting. Furthermore, the risk exists that release problems come up, due to milling the ribbons in the presence of magnesium stearate, since thereby the hydrophobic magnesium stearate is distributed better on the surface of the granulate particles, which may result in a poorer wettability. This improved distribution over the surface of the granulate particles can further lead to a reduction in tablet strength during the subsequent tablet compaction process.

If the magnesium stearate concentration in the mixture to be compacted is reduced below e.g. 0.3% (w/w) or, if the addition of magnesium stearate is completely dispensed with, problems such as the reduction in compactibility and release caused by magnesium stearate may be eliminated or reduced to an acceptable degree. However, this generally results in an increase of pieces of ribbons sticking/caking to the press roll surface. Even if these residues can be removed mechanically from the press rolls by so-called ribbon scrapers, which by the way do not touch the roll surface, before this press roll section is used again for ribbon compaction, it cannot be prevented in general that the press roll surfaces are provided with cakings (pieces of ribbons, sticking to the press roll surface) of varying thickness. Such cakings cause considerable gap fluctuations, resulting in ribbons with (markedly) larger fluctuations in the apparent density than would be the case without such sticking/caking pieces of ribbons. Since fluctuations in ribbon density cause fluctuations in ribbon strength, this may entail problems in granulate flow properties and tablet compactibility, which is perceivable in form of fluctuations in tablet weight and tablet strength, respectively.

A further problem associated with sticking/caking is the determination of the apparent ribbon density during manufacturing these ribbons.

This density, which is determined whilst the ribbon is still positioned between the press rolls (=so-called “at gap” density (gap=smallest effective distance between the press rolls)), is calculated from the ribbon amount manufactured per time unit (=amount of granulate under “steady state” conditions) and the volume manufactured between the press rolls. To calculate this volume, the average gap over the selected time period has to be determined, which can only be achieved with sufficient accuracy (of 1.5% or better, but in any case better than 3%), if no or few ribbon pieces are sticking/caking on the press roll surfaces.

This “at gap” density is a direct measure of the apparent density of the ribbons, which in turn basically determines ribbon properties and those of the resulting granulate, such that monitoring or even controlling this “at gap” density is extremely relevant to granulate quality. Too low a density results in too low a mechanical strength (hardness), and thus to an elevated amount of fine powder, which in turn causes flowability problems upon tableting. If the density is too high, this generally results in problems as to achieving the required tablet strength/hardness (=tensile strength) upon tableting. Since the relation between “at gap” density and the mechanical ribbon strength may vary from batch to batch, a direct determination of ribbon strength is to be preferred, yet a reliable determination of the “at gap” density continues to be important, since manufacturing ribbons with a high apparent density may result in granulates with compaction problems with respect to tablet hardness.

A reliable determination of the “at gap” density is thus of large economical interest, since faulty productions, associated with considerable costs, can be prevented therewith. Therefore, sticking/caking on the press roll surfaces as described has to be avoided or reduced to such a low level that the accuracy required for determining the “at gap” density is ensured.

As recently described in literature (Dawes et al.), such sticking/caking can be prevented if a solvent-containing suspension of magnesium stearate is sprayed on the press roll surface. To this end, an organic solvent is used, so that this largely evaporates before the spray jet impinges the press roll surface.

However, in this case granulate solvent contamination is unavoidable, both in devices, in which the milling of the ribbon is performed in a separate process housing adjacent to the ribbon manufacture housing and, and in particular, in devices wherein the milling is performed in the same housing than the one in which the ribbons are produced. The reason for this is that solvent vapours are absorbed by granulate particle surfaces, making it difficult or even impossible to prevent contamination of the tablets subsequently manufactured from this granulate. Removal of these solvent residues from the granulate and/or the tablets is likely to be relatively difficult and cost-intensive, and hence, spraying a solvent-containing magnesium stearate suspension does not represent an economically sensible solution for the prevention of sticking/caking on press roll surfaces and/or for the reduction of internal magnesium stearate concentration.

Furthermore, the disposal of such solvent-containing vapours causes an increase of production costs; and further additional analytical costs are incurred upon quality control.

Since such spraying systems are frequently operated with compressed air, the corresponding amounts of air also have to be passed from the process housing, causing additional costs, since these particles containing amounts of air must be passed through filters, since the escape of fine powder particles from the process housing is at least undesirable and in many cases even associated with danger to the operators.

The object of the invention is on the one hand to prevent sticking/caking and the problems associated therewith completely or virtually completely, and on the other hand to reduce the amount of internal lubricant and/or anti-adhesive, and particularly magnesium stearate, to such an extent that neither problems, caused by these agents, occur during tableting nor the release of active ingredients upon dissolution of the tablets is affected negatively. Due to the economic and procedural disadvantages associated with the use of solvents, this task should now be put into practice without the use of solvents.

This task is solved by the invention in such a way that the press rolls are coated continuously and without any solvents with a thin layer of lubricant and/or anti-adhesive.

Solvent-free coating offers the advantage that the product does not require post-treatment. If possible at all, it would be extremely tedious to remove any solvents from the product. A further advantage of this solvent-free coating is that sticking/caking on the press roll surfaces is prevented completely or to the greatest possible extent. This enables the production of ribbons with smaller fluctuations in apparent density. This results in an improved granulate quality.

Coating with a lubricant and/or an anti-adhesive, in particular with magnesium stearate, has the advantage that magnesium stearate is most frequently used as a lubricant and/or anti-adhesive in the pharmaceutical industry and is approved by the authorities.

Furthermore, the coating with a magnesium stearate-containing powder mixture has been proved to be of value. Also a mixture comprising magnesium stearate in combination with an excipient or excipient mixture consisting of substances already contained in the formulation, has been shown to be suitable.

Also the coating with one or more pressed articles containing a suitable lubricant and/or anti-adhesive, preferably magnesium stearate, has been shown to be suitable. These pressed articles are produced for instance by compacting magnesium stearate-containing powders using tablet presses. In this way, magnesium stearate-containing pressed articles of sufficient mechanical strength can be produced by adding, e.g. well-compactable substances such as micro-crystalline celluloses, which are very commonly used in the formulation. By pressing these pressed articles at a moderate pressure onto the surface of the press rolls, a direct coating of these rolls is realized.

The advantage of such pressed articles is that they can be replenished easily in a containment area. Furthermore, pressed articles occupy less volume than a powder having the same magnesium stearate concentration.

A further advantage of these coatings is that the increase in the concentration of lubricant and/or anti-adhesive, in particular magnesium stearate, in the product made with the roller compaction device is less than 0.01% to 0.2% (w/w), and generally less than 0.04 to 0.1% (w/w). Nonetheless, sticking/caking on the press roll surfaces was prevented completely or reduced to an irrelevant level. In general, in order to prevent sticking/caking by adding internal lubricants and/or anti-adhesives, in particular magnesium stearate, significantly higher concentrations are required, namely from 0.5% to 1.5%. In contrast, external lubrication only causes an increase of the concentration of the lubricant and/or anti-adhesive in the product, in particular of magnesium stearate, of 0.04% to 0.1%, in general.

A reduction in the lubricant and/or anti-adhesive concentration, in particular of magnesium stearate, in turn works extremely advantageously in solving problems induced by the lubricant and/or anti-adhesive, in particular by magnesium stearate, in preparing tablets with sufficient mechanical strength from the granules. The reduction works equally advantageous in solving problems, caused by lubricants and/or anti-adhesives, in particular by magnesium stearate, with regard to the release of the active ingredient from tablets or capsules.

A further advantage of the invention is that sticking/caking on the press roll surfaces is prevented, so that the ribbon volume produced per time unit between the press rolls whilst being pressurized can be determined with an accuracy of better than 3%, preferably better than 2%, and in particular better than 1.5%. This is the basis for a correspondingly accurate determination of the apparent density of the ribbons located between the press rolls whilst being pressurized (=“at gap” density), since this is calculated from the amount (=mass) of ribbons, respectively granulate produced per time unit and the ribbon volume manufactured between the press rolls per time unit. This accuracy is only possible, if the press rolls are free of sticking/caking pieces of ribbon or if sticking/caking is reduced to an insignificant level.

Possibly, external lubrication may even allow to completely do without the addition of lubricant and/or anti-adhesive, in particular of magnesium stearate, to the powder to be compacted, so that potential problems regarding the re-compactibility of the original powder mixture (=compactibility of the obtained granulates) to tablets with sufficient mechanical strength and/or the release of the active ingredient from tablets or capsules are resolved.

A further advantage is that particularly with the application of a layer of powder according to the invention, the anti-adhesives containing aggregates are not pressed onto the press roll surface and are not distributed as uniformly as possible over its surface. In this way, the occurrence of a preferably low friction coefficient between the product to be compacted and the press roll surface is avoided, so that the draw-in of powder between the press rolls is not unnecessarily aggravated. Such powder draw-in is essential for the roller compaction process.

The invention is to be described in more detail with the aid of drawings as follows:

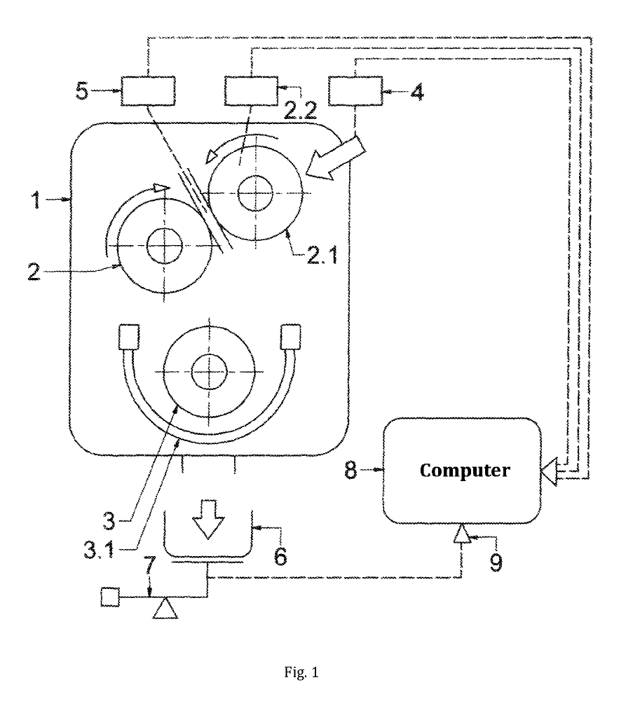

FIG. 1 shows the method of the invention

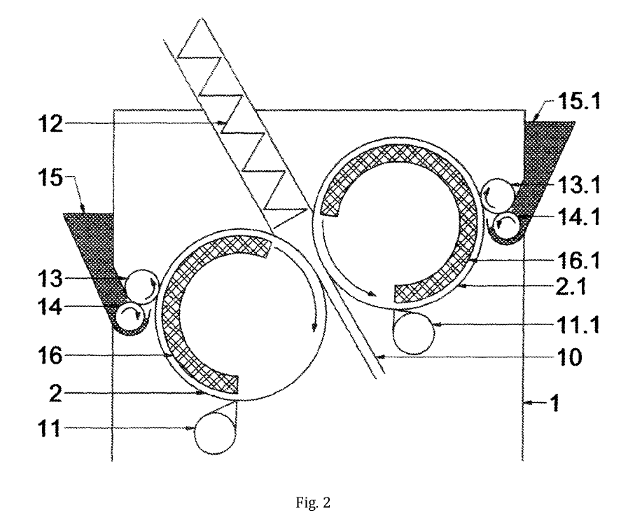

FIG. 2 shows the device according to the invention

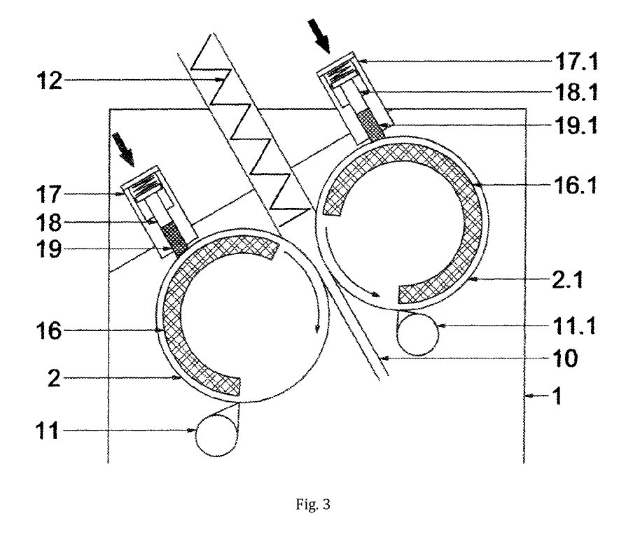

FIG. 3 shows a variant of the device according to the invention

In FIG. 1 reference sign 1 denominates a process housing. Press rolls 2 and 2.1 are arranged inside said process housing 1. The related measuring device 2.2 measures the number of revolutions, or rotations, of press rolls 2 and 2.1. In the lower part of process housing 1, a granulation roll 3, or granulator, with a screen basket 3.1 is arranged. The press roll force is measured using measuring device 4, and the roll gap, or gap, (=smallest effective distance between the press rolls) with measuring device 5. Beneath the process housing 1, a drum 6 is positioned for collecting the dry granules, the drum standing on a scale 7, which is connected to a computer 8 via collector line 9. More than one collector line may be required, depending on how many load cells are required.

In FIG. 2 and FIG. 3, same reference signs denominate same parts as in FIG. 1. In FIG. 2, two press rolls 2 and 2.1 are arranged inside the process housing 1. The product is fed via an auger 12, forming a ribbon or flakes 10 after the compaction process between the counter-rotating press rolls 2 and 2.1.

One lubricant feed each is arranged at storage tanks 15 and 15.1 in the lateral area of press rolls 2 and 2.1. Below each storage tank 15 and 15.1, a transfer roll 13 and 13.1 and a conveyor roll 14 and 14.1 are arranged, respectively. The lubricant and/or anti-adhesive feed 15 and 15.1 are positioned on process housing 1 of the roller compaction device in such a way that transfer rolls 13 and 13.1 each touch the press rolls in areas 16 and 16.1, respectively, behind the ribbon scrapers 11 and 11.1 and in front of the auger 12. In this area namely, during roller compaction no ribbons or flakes are expected to be present on the press roll surfaces anymore. It should be emphasised that these ribbon scrapers do not touch the press roll surface, so that abrasion between the press roll surface and the ribbon scrapers is prevented, fundamentally.

The application of a thin layer of lubricant and/or anti-adhesive with the help of a conveyor- and a transfer roll may also take place with a device consisting of more than two rolls, such as for instance two conveyor rolls and one transfer roll. Also, each press roll may be equipped with several of such application devices in order to apply a thin layer of powder to the press roll surface. The diameters of conveyor- and transfer-rolls may be identical or different. It is irrelevant whether the diameter of the conveyor roll is larger or smaller compared to the one of the transfer roll.

During compaction, the lubricant feed storage tanks 15 and 15.1 (FIG. 2) contain a suitable lubricant and/or anti-adhesive, preferably magnesium stearate or a magnesium stearate containing powder mixture, which is transferred by the conveyor roll 14, respectively 14.1, to the transfer roll 13, respectively 13.1. The transfer roll 13, respectively 13.1, then applies the lubricant and/or anti-adhesive to the surface of press roll 2, respectively 2.1.

The object of the invention may also be achieved with the aid of pressed articles containing a suitable lubricant and/or anti-adhesive, preferably magnesium stearate. These pressed articles may for example be produced by compaction of magnesium stearate containing powders with the aid of suitable (tablet) presses. During manufacture it has to be ensured that the lubricant and/or anti-adhesive properties of the substances used are maintained at an adequate level. For this reason, extrusion-or melt processes are not acceptable for the manufacture of such magnesium stearate containing pressed articles, because this will substantially reduce the lubricant and/or anti-adhesive properties of magnesium stearate.

The lubricant and/or anti-adhesive containing pressed articles are denominated with reference signs 19, respectively 19.1 (FIG. 3). These sufficiently strong pressed articles are pressed directly onto the surface of the press rolls 2, respectively 2.1, with an adjustable, preferably constant force, schematically represented by the spring assembly 18, respectively 18.1, in FIG. 3. The device by which these pressed articles are pressed onto the press roll surface as well as the pressed articles themselves are arranged in housing 17, respectively 17.1. As a matter of principle, the housing containing the pressed articles is also arranged in the press roll area, in which no ribbons or flakes or only small, for the process irrelevant amounts of ribbons or flakes are expected to be present on the respective press roll surfaces. Accordingly, the device by which these pressed articles are pressed onto the press roll surface as well as the pressed articles comprised therein are arranged in the area between the respective ribbon scraper (11, respectively 11.1) and the auger (12), which in FIG. 3 is schematically represented by the shaded areas 16 and 16.1.

With both the devices shown in FIG. 2 and in FIG. 3, thin layers of lubricant and/or anti-adhesive, preferably magnesium stearate, are reproducibly applied to the press roll surface. In this respect, only one of these surface coating devices per press roll would suffice, but of course it is also possible to use combinations thereof.

The precise amount of lubricant and/or anti-adhesive, preferably magnesium stearate or a magnesium stearate containing mixture, which are applied by these coating devices and finally are collected from the press roll surface by the powder to be roller compacted, depends on the process conditions selected, e.g. on the surface constitution of the conveyor- and the transfer rolls (nos. 13, respectively 13.1, in FIG. 2), the contact pressure and mechanical strength of the pressed articles (nos. 19, respectively 19.1, in FIG. 3), the constitution of the surface of the press rolls (nos. 2, respectively 2.1, in FIG. 3) (e.g. smooth, roughened, knurled or pocket-type press roll surfaces) and the properties of the powder to be compacted.

This causes fluctuations in the amount of lubricant and/or anti-adhesive, in particular magnesium stearate, finally collected from the press roll surface by the powder, ranging from 0.015 mg to 0.2 mg, particularly between 0.03 mg and 0.05 mg magnesium stearate per square centimetre press roll surface. And this in turn, depending on the roll force, or press force, and the gap selected, results in an increase in the magnesium stearate concentration in the ribbon, respectively the granulate, ranging between 0.01% and 0.2% (w/w), and particularly between 0.04% and 0.1% (w/w). And thus, the amount of magnesium stearate introduced into the product by this solvent-free coating is significantly smaller than the amount needed in case of an internal lubrication for preventing completely or almost completely sticking/caking on the press roll surfaces. In order to prevent this sticking/caking by internal lubrication, internal concentrations between 0.5% and 1.5% (w/w) are normally required, depending on product properties and surface properties of the press roll.

With such magnesium stearate application devices, several substances could be roller compacted and milled immaculately without material build-up, or sticking/caking, on the press rolls. In general, it was not necessary to accept essential limitations regarding the possible process parameters such as roll force (or press force), roll gap and/or press roll speed (number of roll revolutions per time unit), also called manufacturing parameters, which are relevant concerning dry granulation based on roller compaction.

For instance, when using smooth press roll surfaces, the sticking/caking-prone substance citric acid could be processed without addition of the (internal) lubricant magnesium stearate over the same range of manufacturing parameter as employed for magnesium stearate coated press rolls. In fact, by coating with magnesium stearate sticking/caking was prevented completely or reduced to an irrelevant level. For gaps up to 24 mm per metre press roll diameter, roll forces, or press forces, up to 80 kN per centimetre press roll width and per meter press roll diameter were possible, being the whole force range of the roller compaction device being used.

Although by adding 1% magnesium stearate to this powder (so-called internal magnesium stearate) sticking/caking could also be largely prevented, the range of possible manufacturing parameter was considerably reduced thereby. In this case, when using press rolls with a smooth surface, only roll forces up to 48 kN per centimetre press roll width and per metre press roll diameter could be achieved irrespective of the selected gap. And at a gap of 18 mm per metre press roll diameter, a roll force of only up to 20 kN per centimetre press roll width and per metre press roll diameter could be applied.

The same smooth press roll surface was also used for compacting citric acid without internal magnesium stearate but with magnesium stearate coated press rolls. Upon externally coating with magnesium stearate, the ribbons indeed contained clearly less than 1% magnesium stearate, namely between 0.01% and maximum 0.1% (w/w) magnesium stearate, depending on the selected press rolls of the powder coating unit or the contact pressure of the pressed articles (the latter ones being prepared from a magnesium stearate containing powder mixture) and their mechanical strength.

Also when compacting mannitol using smooth, magnesium stearate coated press roll surfaces, in comparison to non-lubricated powder, no significant limitations to the manufacturing parameters were observed which are relevant for dry granulation with a roller compaction device. Also with mannitol, external coating of the press roll surfaces enabled a reduction of the magnesium stearate concentration in the roller compacted product by at least a factor of 10 to 0.1% (w/w). Generally, concentrations of 0.02% to 0.05% (w/w) were achieved, which is up to a factor of 50 less than with internal lubrication.

Even though by coating the press roll surface with magnesium stearate usually no significant limitations to roller compaction parameters have to be accepted which are relevant to dry granulation using roller compaction—in comparison to non-lubricated powder—this does not apply for each powder to be roller compacted. Limitations regarding compaction between the press rolls may for instance be caused by a thin magnesium stearate layer leading to so-called draw-in problems. Especially, when using smooth press roll surfaces, for certain materials, like e.g. corn starch, this phenomenon is so pronounced that roller compaction is only possible at low forces and/or gap widths.

During the roller compaction of corn starch using smooth press roll surfaces, the manufacturing parameter range was already massively constrained at an internal magnesium stearate quantity of 0.1% (w/w). With corn starch, an internal magnesium stearate quantity of only 0.1% whilst using with smooth press rolls only a roll force of maximally 28 kN per centimetre press roll width and per metre press roll diameter could be applied at a gap of 4 mm per metre press roll diameter. From a gap of 8 mm per metre press roll diameter, a roll force of only 12 kN per centimetre press roll width and per metre press roll diameter could be exerted. From a gap of 12 mm per metre press roll diameter no significant roll force could be exerted, anymore.

However, if the surface of a smooth roll was roughened in such a way that the press rolls thereafter exhibited a surface roughness from 0.5 μm to 1.5 μm thereafter, and particularly from 0.8 μm to 1.2 μm, then the internal magnesium stearate concentration of 0.1% in the corn starch product still caused a reduction in the possible roller compaction parameter range compared to the non-lubricated product, but this reduction was and generally is of little practical significance for dry granulation by roller compaction. Also upon addition of 1% internal magnesium stearate together with the above-mentioned smooth but roughened press roll surfaces, the manufacturing parameter range was still sufficiently large (although slightly less than with an internal magnesium stearate concentration of 0.1% (w/w)), but the external lubrication of the press roll surfaces resulted not only in a slightly larger manufacturing parameter range than with an internal quantity of magnesium stearate of 1% but also in a much smaller concentration of magnesium stearate in the roller compacted product. The latter was lowered by a factor of 10 to 50, namely 0.1% to 0.02% depending on the constitution of the transfer rolls when using the roll-based coating device (refer to FIG. 2). Further, the press roll surfaces remained free of sticking/caking.

These results clearly show that the use of roughened press roll surfaces, characterized by press roll surfaces exhibiting a surface roughness from 0.5 μm to 1.5 μm, preferably from 0.8 μm to 1.2 μm, in combination with a device for applying a thin layer of a lubricant and/or an anti-adhesive, in particular magnesium stearate, are excellently suited for the compaction of powders with the aid of a roller compaction device, whereupon not only a sufficiently broad manufacturing parameter range is guaranteed, but whereupon also the magnesium stearate concentration in the granulate increases by only 0.01% to 0.2% (w/w), particularly by only 0.04% to 0.1% (w/w). At the same time, the press roll surfaces remain free of sticking/caking or the level of sticking/caking is so small that it has no influence on granulate quality or only an irrelevant one. In addition, this also ensures that the “at gap” density can be determined with an accuracy of 1.5% or better, but in any case better than 3%.

In some cases (e.g. for the product Neosorb), it was surprisingly noted that external lubrication even resulted in a minor extension of the roller compaction parameter range (though only of little practical relevance for dry granulation). In this case smooth but roughened press rolls were used. By externally applying a thin layer of magnesium stearate on the press rolls using the device by which magnesium stearate containing pressed articles were pressed onto the surface as shown in FIG. 3, the manufacturing parameter range could be extended from 72 kN to 80 kN per centimetre press roll width and per metre press roll diameter at a gap of 16 mm per metre press roll diameter. Also in this case, only small concentrations of magnesium stearate were measured in the roller compacted product, namely 0.04% to maximally of 0.12% (w/w).

1-12. (canceled)

13. A method for the external lubrication of rotating press rolls of a roller compaction device by continuous coating of the rotating press rolls, comprising coating the press rolls with a thin layer of a lubricant and/or an anti-adhesive in a continuous and solvent-free manner.

14. The method according to claim 13, wherein the coating is performed with a magnesium stearate powder.

15. The method according to claim 13, wherein the coating is performed with a magnesium stearate-containing powder mixture.

16. The method according to claim 13, wherein the coating is performed with one or more pressed articles consisting of a magnesium stearate-containing mixture.

17. The method according to claim 13, wherein the press roll surfaces exhibit a surface roughness ranging from 0.5 μm to 1.5 μm.

18. The method according to claim 13, wherein the press roll surfaces exhibit a surface roughness ranging from 0.8 μm to 1.2 μm.

19. The method according to claim 14, wherein the amount of magnesium stearate collected from the press roll surfaces by the product to be roller compacted ranges from 0.015 mg to 0.2 mg per square centimeter press roll surface.

20. The method according to claim 14, wherein the amount of magnesium stearate collected from the press roll surfaces by the product to be roller compacted ranges from 0.03 mg to 0.05 mg per square centimeter press roll surface.

21. The method according to claim 13, wherein the concentration of lubricant and/or anti-adhesive, particularly magnesium stearate, in the dry granules increases by less than 0.01% to 0.2% (w/w).

22. The method according to claim 13, wherein the concentration of lubricant and/or anti-adhesive, particularly magnesium stearate, in the dry granules increases by less than 0.04% to 0.1% (w/w).

23. The method according to claims 13, wherein the apparent density of the ribbons located between the press rolls whilst under pressure can be determined with an accuracy of better than 3%.

24. The method according to claims 13, wherein the apparent density of the ribbons located between the press rolls whilst under pressure can be determined with an accuracy of better than 2%.

25. The method according to claims 13, wherein the apparent density of the ribbons located between the press rolls whilst under pressure can be determined with an accuracy of better than 1.5%.

26. A device for the external lubrication of press rolls in a roller compaction device resulting in continuous coating of the rotating press rolls, comprising a housing in which the press rolls are arranged, the housing comprising at least one coating device based on rolls or a coating device based on pressed articles by which at least one press roll is coated.

27. The device according to claim 26, wherein a transfer roll is arranged between a ribbon scraper and an auger.

28. The device according to claim 27, wherein the pressed articles are pressed onto the press roll surfaces between the ribbon scraper and the auger.

29. A method of manufacturing dry granules, comprising a step of roller compacting powders into dry granules with the device according to claim 26.
